(19) United States
(12) Patent Application Publication
(10) Pub. No.: US 2025/0307425 A1
(43) Pub. Date: Oct. 2, 2025

(54) CENTRALIZED COMPLIANCE MANAGEMENT PLATFORM FOR RISK ANALYSIS OF SECURITY OBJECTS

(71) Applicant: Entrust Corporation, Shakopee, MN (US)

(72) Inventors: MICHAEL LOGER, Munich (DE); TUSHAR TAMBAY, Mountain View, CA (US); SHARDUL DIVATIA, Fremont, CA (US); PATRICIA POWERS, Auburn, NH (US); CELSINA BIGNOLI, San Francisco, CA (US)

(21) Appl. No.: 19/091,491

(22) Filed: Mar. 26, 2025

Related U.S. Application Data
(60) Provisional application No. 63/571,250, filed on Mar. 28, 2024.

(51) Int. Cl. G06F 21/57

(52) U.S. Cl. CPC G06F 21/577; G06F 2221/034

(57) ABSTRACT

A centralized compliance management platform for risk analysis of security objects is provided. Such a centralized compliance platform performs discovery across the enterprise to obtain information about the varying security objects used by that organization, for example via application programming interface (API) connections to enterprise key and secret vaults, as well as certificate storage locations. Using metadata associated with the security objects, the platform may calculate risk scores for security object storage locations within the enterprise. The platform may generate a user interface at which risk scores associated with security object storage locations may be monitored.

### CROSS-REFERENCE TO RELATED APPLICATIONS

This application claims priority to U.S. Provisional Patent Application No. 63/571,250, filed Mar. 28, 2024, the disclosure of which is hereby incorporated by reference in its entirety.

### BACKGROUND

Large enterprises store a wide variety of types of secure data. Such secure data is typically maintained in a secure state through use of security objects, for example, encryption keys, secrets, and certificates. Such security objects may be maintained in various secure storage locations, for example in an on-premises appliance, such as a Hardware Security Module (HSM), or within various virtual appliances like key vaults, secret vaults, or certificate storage locations either within the enterprise or within private or public cloud storage.

To maintain enterprise data securely, these security objects are typically maintained with a goal of compliance with predefined enterprise security standards. For example, certificates that include encryption keys therein may be inspected to ensure that the encryption key is of adequate length to meet enterprise standards. However, such maintenance may be difficult, because certain security objects, such as keys and secrets, may be maintained within distributed physical or virtual “vaults” throughout an enterprise. Such vaults may be distributed across an organization and represent the single control point for each respective security objects maintained by those vaults. Further, with a large number of vaults, and multiple security objects maintained within each vault, it may be difficult to determine whether the vaults and the stored security objects are properly secured or at risk of being compromised.

### SUMMARY

Generally speaking, the present disclosure is related to a centralized compliance management platform for risk analysis of security objects. In example embodiments, the platform compiles metadata associated with security objects maintained within registered security object storage locations. The metadata may define properties of security objects maintained by the centralized compliance management platform. The platform may use the metadata to calculate risk scores for the security object storage locations and present the risk scores in a user interface. Such risk scores may be based on defined compliance policies and prioritization, as defined in a risk scoring template, and may be automatically updated in response to adjustment of the properties of the security objects and/or risk scoring prioritization defined in the risk scoring template.

In a first aspect, a method of managing security object storage locations is provided. A security object storage location is registered at a compliance management platform. The security object storage location maintains one or more security objects. For each security object maintained in the security object storage location, metadata associated with the security object is received and a risk score is assigned to the security object based on the received metadata. An overall risk score for the security object storage location is calculated based on the risk scores of the one or more security objects. An administrative user interface is generated at the compliance management platform. The administrative user interface includes a display of the overall risk score for the security object storage location.

In a second aspect, a security object compliance management platform is provided. The security object compliance management platform includes a computing system including a processor and memory. The memory stores instructions executable by the processor to register a security object storage location at the security object compliance management platform. The security object storage location maintains one or more security objects. The instructions further cause the processor to, for each security object maintained in the security object storage location, receive metadata associated with the security object and assign a risk score to the security object based on the received metadata. The instructions further cause the processor to calculate an overall risk score for the security object storage location based on the risk scores of the one or more security objects and generate an administrative user interface at the security object compliance management platform. The administrative user interface includes a display of the overall risk score for the security object storage location.

In a third aspect, a non-transitory computer-readable medium comprising computer-executable instructions installed thereon is provided. The computer-executable instructions are executable by a computing system to cause the computing system to perform a method of managing compliance with security policies of an enterprise for one or more security objects maintained across a distributed set of security object storage locations. The method includes registering a security object storage location at a compliance management platform. The security object storage location maintains one or more security objects. The method further includes, for each security object maintained in the security object storage location, receiving metadata associated with the security object and assigning a risk score to the security object based on the received metadata. The method further includes calculating an overall risk score for the security object storage location based on the risk scores of the one or more security objects and generating an administrative user interface at the compliance management platform. The administrative user interface includes a display of the overall risk score for the security object storage location.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example enterprise environment in which aspects of a centralized compliance platform may be implemented.

FIG. 2 illustrates connection of a centralized compliance platform to a plurality of security object storage systems, according to an example embodiment.

FIG. 3 illustrates a computing device on which aspects of the present disclosure may be implemented.

FIG. 4 illustrates a flowchart of an example method of managing security object storage locations.

FIG. 5 illustrates an example centralized user interface generated by a centralized compliance platform and displaying a dashboard view, according to an example embodiment.

FIG. 6 illustrates an example centralized user interface generated by a centralized compliance platform and displaying a further portion of a dashboard view, according to an example embodiment.

FIG. 7 illustrates an example centralized user interface generated by a centralized compliance platform and displaying a distributed storage location definition view, according to an example embodiment.

FIG. 8 illustrates an example centralized user interface generated by a centralized compliance platform and displaying a distributed storage location display view, according to an example embodiment.

FIG. 9 illustrates an example centralized user interface generated by a centralized compliance platform and displaying a vault details view, according to an example embodiment.

FIG. 10 illustrates an example centralized user interface generated by a centralized compliance platform and displaying a risk scoring template view, according to an example embodiment.

FIG. 11 illustrates an example centralized user interface generated by a centralized compliance platform and displaying a detected security objects view, according to an example embodiment.

FIG. 12 illustrates an example centralized user interface generated by a centralized compliance platform and displaying a detected security objects view with a risk score window, according to an example embodiment.

FIG. 13 illustrates an example centralized user interface generated by a centralized compliance platform and displaying a security objects view, according to an example embodiment.

FIG. 14 illustrates an example centralized user interface generated by a centralized compliance platform and displaying a documentation information view, according to an example embodiment.

FIG. 15 illustrates an example centralized user interface generated by a centralized compliance platform and displaying a policy compliance definition view, according to an example embodiment.

FIG. 16 illustrates an example centralized user interface generated by a centralized compliance platform and displaying a documentation template view, according to an example embodiment.

### DETAILED DESCRIPTION

As briefly described above, embodiments of the present invention are directed to a centralized compliance management platform for risk analysis of security objects. Such a centralized compliance platform performs discovery across the enterprise to obtain information about the varying security objects and security object storage locations used by that organization, for example via application programming interface (API) connections to enterprise key and secret vaults, as well as certificate storage locations. Examples of centralized compliance platforms are described in U.S. patent application Ser. No. 18/411,632, filed on Jan. 12, 2024, and entitled “Centralized Compliance Management Platform for Security Objects,” the disclosure of which is hereby incorporated by reference in its entirety.

Using the information discovered about the security objects and security object storage locations, the platform may calculate risk scores for the security objects and the security object storage locations. In examples, the risk scores represent a quantifiable measure of the risk of the security objects being compromised. As described further herein, the risk scores may be based on properties of the security objects and the security object storage locations derived from metadata associated with the security objects and the security object storage locations.

In examples, the centralized compliance platform, also referred to herein as a compliance management platform, allows for a single view of risk scores for security objects and security object storage locations that are maintained across an enterprise without requiring centralization of those security objects or security object storage locations. Rather, security objects (e.g., keys, secrets, certificates, and the like) may be maintained within distributed storage locations (e.g., key vaults, secret vaults, and secure certificate databases, and the like) within the enterprise, and metadata describing such security objects and their storage locations may be collected. In this way, risk scores associated with the security object and security object storage locations can be assessed and quickly reported to administrative personnel (e.g., enterprise security administrators).

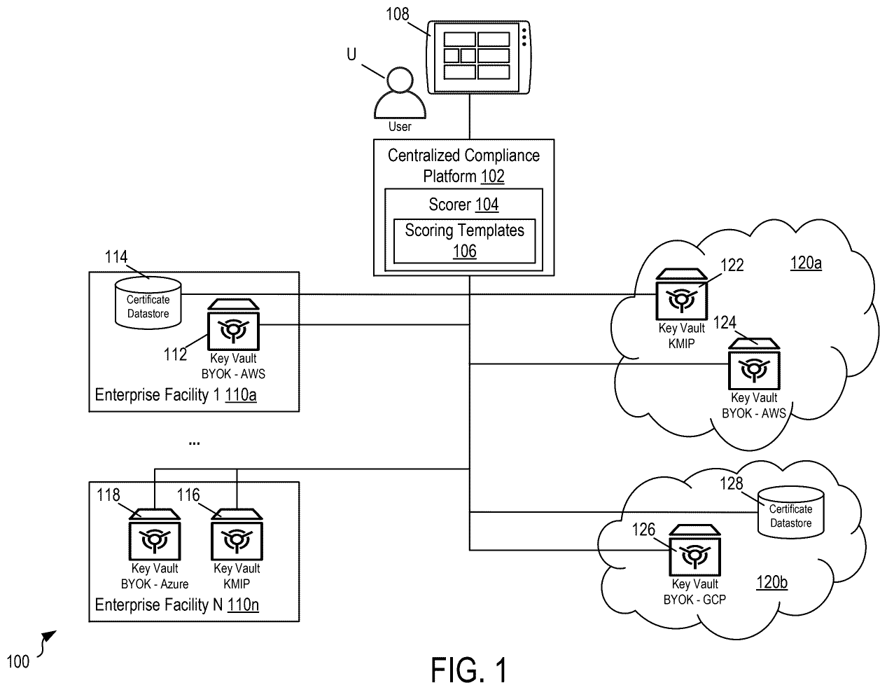

Referring now to FIG. 1, an example enterprise environment 100 is shown, in which aspects of a centralized compliance platform may be implemented. A centralized compliance platform 102 may generate and present a user interface to a user U, for example on a user device 108. In embodiments, the user interface presented to the user U includes risk scores calculated for security object storage locations within the enterprise environment 100. The user device 108 may be located locally to, or remote from, the centralized compliance platform 102.

In the example shown, the centralized compliance platform 102 may be configured to discover, and connect to, a plurality of enterprise security object storage locations. The centralized compliance platform 102 may be configured to discover details regarding such security object storage locations, as well as the security objects stored therein.

In the example shown, an enterprise may have a plurality of enterprise facilities 110a-n, at which various computing resources may be located. Such computing resources may include, for example, key vaults, certificates storage databases, secret vaults, and the like. Various types of key or secret vaults may be maintained at each facility. For example, a Key Management Interoperability Protocol (KMIP) vault, a secrets vault, and/or a Transparent Data Encryption (TDE) key vault may be implemented. In the example shown, a first enterprise facility 110a includes a first key vault 112, as well as a certificate database 114. A second enterprise facility 110n includes two additional key vaults 116, 118. Key vaults 116, 118 are shown to be different types of key vaults, e.g., specific to various cloud security keys, local keys, and the like.

In addition to the enterprise facilities 110a-n, one or more cloud storage locations 120a-b may be included within control of an enterprise, and may host various types of security object storage locations. In the example shown, a first cloud storage location 120a includes two different key vaults 122, 124, each representing a different type of key vault (e.g., a KMIP vault and a “Bring Your Own Key” (BYOK) vault). A second cloud storage location 120b can include a further key vault 126, as well as a certificate data store 128. In the example shown, although the first and second cloud storage locations each maintain a BYOK vault (e.g., vaults 124, 126), these key vaults may store different types of keys, for example keys associated with different cloud storage providers, such as Amazon, Google, Azure, and the like.

In example implementations, the centralized compliance platform 102 may be configured to perform a discovery process across the various security object storage locations, for example by automatically analyzing an enterprise infrastructure to identify particular storage locations. In further embodiments, the centralized compliance platform 102 may receive a definition of a storage location, for example from a user via a user interface at user device 108. Examples of receipt of such a definition of a security object storage location are provided below.

After identifying the security object storage locations, the centralized compliance platform 102 can calculate risk scores for the security objects and the security object storage locations. In the illustrated embodiment, the centralized compliance platform 102 includes a scorer 104, which calculates the risk scores. As described herein, the scorer 104 may calculate the risk scores based on scoring templates 106. Examples of scoring templates 106 include documentation templates that define documentation information to be collected from the user U regarding security objects and risk score templates that define a mapping between properties of security objects and risk scores.

In embodiments, the scorer 104 calculates a risk score for a security object storage location by calculating risk scores for each of the security objects maintained within the security object storage location and determining an overall risk score for the security object storage location based on the security object risk scores (e.g., by taking an average of the risk scores of the security objects maintained within the security object storage location).

In an example, the scorer 104 calculates a risk score for a security object based on properties of the security object. The properties of the security object considered in calculating a risk score for the security object may include properties related to compliance of the security object with compliance policies as well as documentation of the security object. Examples of properties considered in determining a risk score for a security object include age of the security object, whether the security object is documented, whether the security object is protected in a hardware security module (HSM), and the criticality, purpose, and confidentiality of the data protected by or stored within the security object.

The scorer 104 may use metadata associated with the security object to determine the properties of the security object. For example, the scorer 104 may automatically retrieve metadata associated with the security object from the security object. Additionally or alternatively, the metadata used by the scorer 104 may include documentation information entered by a user, such as the user U. As described herein, the scoring templates 106 (e.g., risk score templates and documentation templates) may define what metadata is retrieved by the scorer 104, either automatically or by user input.

Based on the properties of the security object, the scorer 104 may calculate a risk score for the security object. For example, the scorer 104 may assign a risk score to each property based on a mapping defined in a scoring template 106. The scorer 104 may then compute a risk score for the security object as an average of the scores assigned to the properties of the security object.

In an example, the scorer 104 may determine the risk score for a security object based on two properties: whether the security object is protected by an HSM and the age of the security object. Further, a scoring template 106 may map the properties to the following risk scores: HSM protected security objects receive a score of 1, unprotected security objects receive a score of 10, security object less than one year old receive a score of 4, and security objects more than one year old receive a score of 15. In this example, for a security object that is not protected by an HSM and is over a year old, the scorer 104 would map the HSM protection property to a score of 10 (unprotected) and the age property to a score of 15 (more than one year old) and calculate a risk score of 12.5 for the security object (an average of 10 and 15).

As described above, the scorer 104 may calculate an overall risk score for a security object storage location based on the scores calculated for the individual security objects maintained within the security object storage location. For example, the scorer 104 may calculate the overall risk score for the security object storage location as an average of the risk scores of the security objects maintained within the security object storage location. In an example, a security object storage location may maintain three security objects that were assigned the following risk scores: 10, 14, and 15. In this example, the overall risk score for the security object storage location would be 13 (an average of 10, 14, and 15). In alternative examples, different calculations may be used to determine the overall risk score for the security object storage location, including assigning the overall risk score as the highest risk score from among the risk scores calculated for the security objects stored within the security object storage location. Using the same risk scores for three security objects stored within a security object storage location as the previous example, the overall risk score for the security object storage location would be 15 when calculated as a maximum of the individual risk scores of the maintained security objects.

The centralized compliance platform 102 may determine overall risk scores for each of the security object storage locations within the enterprise environment 100 and present a user interface including the calculated overall risk scores on the user device 108. The user interface with the calculated risk scores allows the user U to quickly determine whether there are risks of protected data being comprised in the enterprise.

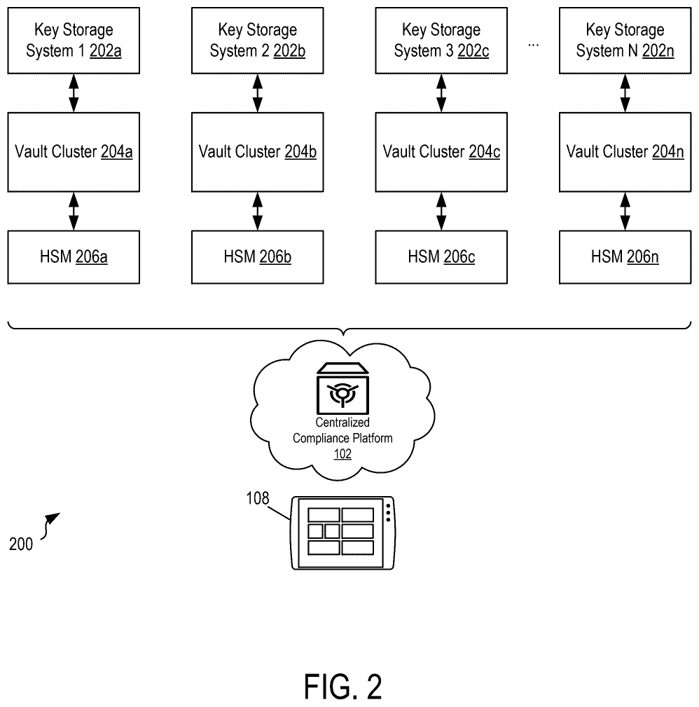

FIG. 2 illustrates connection of a centralized compliance platform 102 to a plurality of security object storage systems, according to an example embodiment. The security object storage systems described herein may represent, or correspond to, the various security object storage locations described above in conjunction with FIG. 1. As above, the centralized compliance platform 102 may be communicatively connected to a user device 108, for viewing and management of security objects and security object storage locations in accordance with principles of the present disclosure.

In particular, FIG. 2 illustrates a hardware arrangement 200 that includes a plurality of key storage systems 202a-n. Each key storage system 202 may be associated with a different vault cluster 204 (individually referred to as vault clusters 204a-n), which may be communicatively connected with, or integrated with, a hardware security module (HSM) 206 (individually referred to as HSMs 206a-n) located at any of a variety of locations within the enterprise. In implementations where the centralized compliance platform 102 receives an identification of a particular security object storage location, the centralized compliance platform 102 may be configured to communicatively connect to any of a key storage system 202, vault cluster 204, or hardware security module 206 directly to obtain security object storage information, including metadata regarding individual security objects and details regarding the location in which those objects are stored.

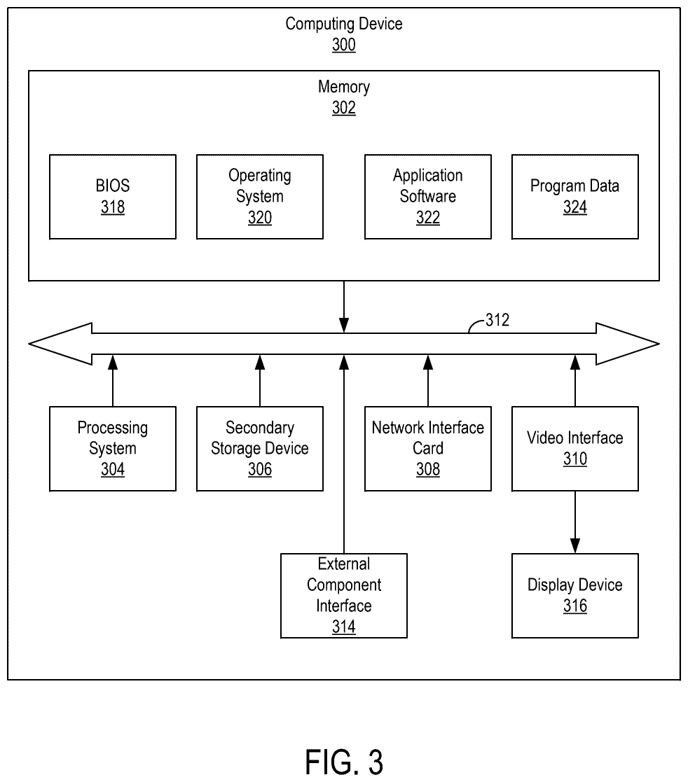

FIG. 3 illustrates an example computing device 300 on which aspects of the present disclosure may be implemented. The computing device 300 can be used, for example, to implement computing devices such as the centralized compliance platform 102, the user device 108, or various enterprise hardware used to implement the security object storage locations described herein.

In the example of FIG. 3, the computing device 300 includes a memory 302, a processing system 304, a secondary storage device 306, a network interface card 308, a video interface 310, a display unit 313, an external component interface 314, and a communication medium 316. The memory 302 includes one or more computer storage media capable of storing data and/or instructions. In different embodiments, the memory 302 is implemented in different ways. For example, the memory 302 can be implemented using various types of computer storage media, and generally includes at least some tangible media. In some embodiments, the memory 302 is implemented using entirely non-transitory media.

The processing system 304 includes one or more processing units, or programmable circuits. A processing unit is a physical device or article of manufacture comprising one or more integrated circuits that selectively execute software instructions. In various embodiments, the processing system 304 is implemented in various ways. For example, the processing system 304 can be implemented as one or more physical or logical processing cores. In another example, the processing system 304 can include one or more separate microprocessors. In yet another example embodiment, the processing system 304 can include an application-specific integrated circuit (ASIC) that provides specific functionality. In yet another example, the processing system 304 provides specific functionality by using an ASIC and by executing computer-executable instructions.

The secondary storage device 306 includes one or more computer storage media. The secondary storage device 306 stores data and software instructions not directly accessible by the processing system 304. In other words, the processing system 304 performs an I/O operation to retrieve data and/or software instructions from the secondary storage device 306. In various embodiments, the secondary storage device 306 includes various types of computer storage media. For example, the secondary storage device 306 can include one or more magnetic disks, magnetic tape drives, optical discs, solid-state memory devices, and/or other types of tangible computer storage media.

The network interface card 308 enables the computing device 300 to send data to and receive data from a communication network. In different embodiments, the network interface card 308 is implemented in different ways. For example, the network interface card 308 can be implemented as an Ethernet interface, a fiber optic network interface, a wireless network interface (e.g., WiFi, WiMax, Bluetooth, etc.), or another type of network interface.

In optional embodiments where included in the computing device 300, the video interface 310 enables the computing device 300 to output video information to the display unit 313. The display unit 313 can be various types of devices for displaying video information, such as an LCD display panel, a plasma screen display panel, a touch-sensitive display panel, an LED or OLED screen, a cathode-ray tube display, or a projector. The video interface 310 can communicate with the display unit 313 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 314 enables the computing device 300 to communicate with external devices. For example, the external component interface 314 can be a USB interface and/or another type of interface that enables the computing device 300 to communicate with external devices or peripheral devices integrated within the same housing (e.g., in the case of mobile devices). In various embodiments, the external component interface 314 enables the computing device 300 to communicate with various external components, such as external storage devices, input devices, speakers, modems, media player docks, other computing devices, scanners, digital cameras, and fingerprint readers.

The communication medium 316 facilitates communication among the hardware components of the computing device 300. The communications medium 316 facilitates communication among the memory 302, the processing system 304, the secondary storage device 306, the network interface card 308, the video interface 310, and the external component interface 314. The communications medium 316 can be implemented in various ways. For example, the communication medium 316 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 302 stores various types of data and/or software instructions. The memory 302 stores a Basic Input/Output System (BIOS) 318 and an operating system 320. The BIOS 318 includes a set of computer-executable instructions that, when executed by the processing system 304, cause the computing device 300 to boot up. The operating system 320 includes a set of computer-executable instructions that, when executed by the processing system 304, cause the computing device 300 to provide an operating system that coordinates the activities and sharing of resources of the computing device 300. Furthermore, the memory 302 stores application software 322. The application software 322 includes computer-executable instructions, that when executed by the processing system 304, cause the computing device 300 to provide one or more applications. The memory 302 also stores program data 324. The program data 324 is data used by programs that execute on the computing device 300.

Although particular features are discussed herein as included within an electronic computing device 300, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include various types of dynamic random access memory (DRAM), solid state memory, read-only memory (ROM), electrically-erasable programmable ROM, magnetic disks (e.g., hard disks, floppy disks, etc.), and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

It is noted that, in some embodiments of the computing device 300 of FIG. 3, the computer-readable instructions are stored on devices that include non-transitory media. In particular embodiments, the computer-readable instructions are stored on entirely non-transitory media.

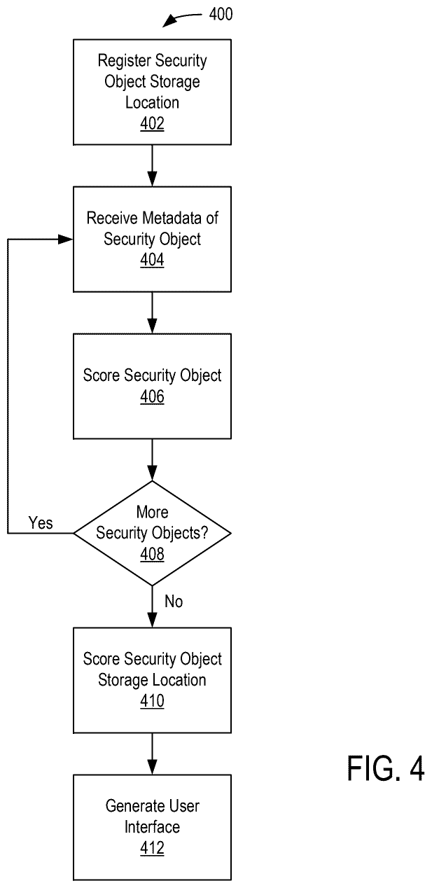

Referring now to FIG. 4, a flowchart of an example method 400 of managing security object storage locations is shown. In the illustrated embodiment, the method 400 includes operations 402, 404, 406, 408, 410, 412. In an example, the method 400 may be performed by a centralized compliance platform, such as the centralized compliance platform 102 described above in conjunction with FIG. 1.

The operation 402 includes registering a security object storage location, which maintains one or more security objects. In an example, connection parameters for the security object storage location are used to communicatively connect to the security object storage location. Examples of connection parameters include vault locations and account details useable for access to security objects maintained within the security object storage location. In an embodiment, a centralized compliance platform registers the security object storage location.

The operation 404 includes receiving metadata associated with a security object maintained within the security object storage location. The metadata may relate to whether the security object is documented, and whether the security object meets enterprise compliance policies. Examples of metadata received include an age of the security object, whether the security object is documented, whether the security object is protected in a hardware security module (HSM), and the criticality, purpose, and confidentiality of the data protected by or stored within the security object. In alternative embodiments, additional or alternative metadata may be received. In some examples, all metadata associated with the security object is received. In alternative examples, only specified metadata is received. The specified metadata may be specified by a user. For example, a user may specify metadata associated with a security object such as by identifying documentation and/or properties of the security object in a user interface of the centralized compliance platform. In an example, at least some of the metadata to be received is identified in a risk scoring template. In embodiments, the metadata associated with the security object is received without receiving the security object itself.

In an embodiment, the metadata includes user-entered documentation information. For example, the criticality, purpose, and confidentiality of the data protected by or stored within the security object may be entered by a user. The documentation information may be entered by the user prior to the method 400 being performed, or the documentation information may be entered during execution of the method 400 (e.g., during the operation 404). In embodiments, the documentation information entered by the user is defined by a documentation template. As described herein, the documentation template may be customized by a user to determine the information to be documented about a security object.

In embodiments, a centralized compliance platform receives the metadata associated with the security object. Because the security object may be stored in a distributed security object storage location, the centralized compliance platform may receive the metadata over a network connection. Additionally, in an example, the centralized compliance platform receives the metadata without receiving the security object itself. This allows the security object to remain secure in the security object storage location while the centralized compliance platform can continue to execute the method 400.

The operation 406 includes calculating a risk score for the security object. In an example, the risk score for the security object is based on the metadata received in the operation 404. In embodiments, the risk score for the security object is calculated by mapping risk scores to properties of the security object identified in the metadata and computing an average from among the property risk scores. In an embodiment, risk scores may range from 1 (low risk) to 25 (high risk).

In an example, a security object may receive the following risk scores for its properties: the security object may be protected by an HSM, which maps to a risk score of 1, and the security object may be more than one year old, which maps to a risk score of 15. In this example, the security object would have a risk score of 8 (an average of 1 and 15).

To weight the importance of properties in determining the risk score for a security object, certain properties may be mapped to higher values than other less important properties. For example, to weight HSM protection higher, a score mapped to a security object not protected by an HSM may be increased from 10 to 20. Because, in some embodiments, the risk score for a security object is an average of the scores assigned to the properties of the security object, increasing the maximum score for a property increases the impact of the property in calculating the risk score for the security object.

In embodiments, the mappings of properties to risk scores are determined by a risk scoring template. If a property for a security object is not defined in the metadata but is included in the risk scoring template, a maximum risk value may be assigned for the property. For example, the risk scoring template may define that HSM protected security objects receive a score of 1 while unprotected security objects receive a score of 10. In this example, if the metadata for a security object does not specify whether the security object is protected by an HSM, the security object receives a score of 10 for that property.

The risk scoring template may also determine how to calculate the risk score for the security object based on the scores assigned to the properties. For example, the risk scoring template may define the risk score for the security object to be the average of the scores assigned to the properties of the security object. In an alternative example, the risk scoring template may define the risk score for the security object to be the maximum risk score from among the scores assigned to the properties of the security object.

In examples, the risk scoring template may be customizable by users to determine which properties to consider in scoring the security object as well as what scores are mapped to each property. Users may also define how to calculate the risk score for the security object based on the scores assigned to the properties. In an example, the risk scoring template is a JSON file. In alternative examples, different data structures may be used to implement the risk scoring template.

In example embodiments, a centralized compliance platform scores the security object. For example, the centralized compliance platform may use a scorer to calculate the score for the security object. The scorer may access templates, such as a risk scoring template, to determine how to score the security object.

In particular, in some embodiments the centralized compliance platform automatically performs a scoring of security objects either periodically, or in response to changes to metadata associated with that particular security object. For example, an initial risk score for a security object may be assigned as “HIGH” when no documentation is associated with that security object. A user may associate documentation describing the security object with the security object within the platform, and in response, the scorer may automatically update a risk score of that object. Furthermore, in response to a user adjusting a risk scoring template, the scorer may automatically update a risk score associated with each security object having a risk score that was calculated using a previous, out of date version of the risk scoring template.

The operations 404 and 406 may be repeated until each security object in the security object storage location is scored. The operation 408 includes determining if more security objects need to be scored. If so, the method 400 returns to the operation 404 and another security object is scored. Once all of the security objects are scored, the method 400 proceeds to the operation 410.

The operation 410 includes scoring the security object storage location. In an example, the risk score for the security object storage location is calculated as an average of the scores for the security objects maintained within the security object storage location calculated in the operation 406. In alternative examples, different scoring methods may be used, including using the maximum score from among the security objects maintained within the security object storage location. In embodiments, the method used to calculate the overall risk score for the security object storage location is determined by a risk scoring template.

In example embodiments, a centralized compliance platform calculates the overall risk score for the security object storage location. For example, a scorer in the centralized compliance platform may use a risk scoring template to calculate the score based on the previously calculated scores of the security objects maintained within the security object storage location.

The operation 412 includes generating a user interface. In an embodiment, the user interface includes the overall risk score for the security object storage location calculated during the operation 410. By presenting the risk score for the security object storage location in a user interface, users can quickly determine whether secure enterprise data is at risk of being compromised. In an embodiment, a centralized compliance platform generates the user interface. The user interface may then be presented to a user on a user device.

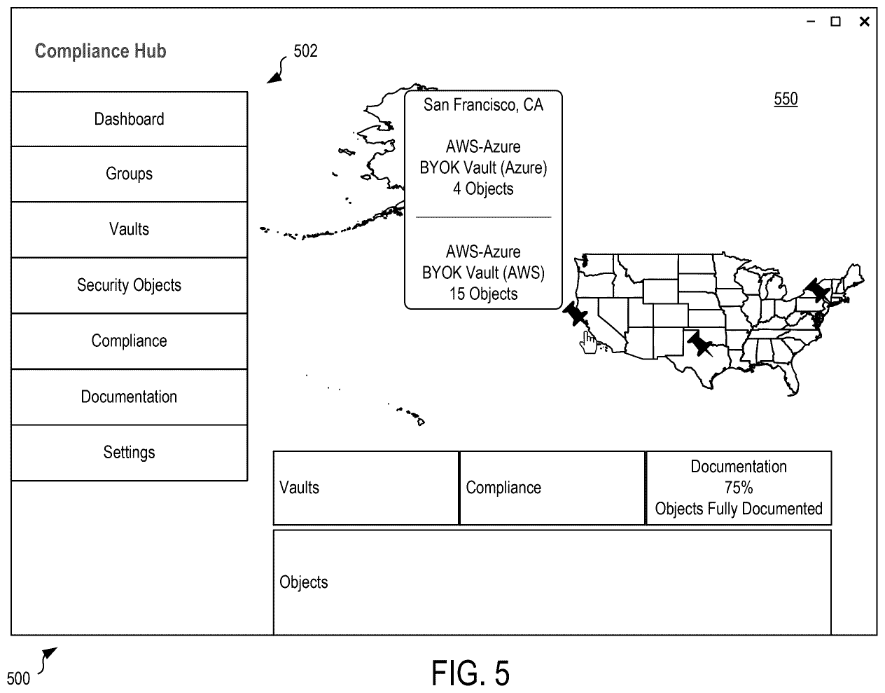

Referring now to FIGS. 5-16, an administrative user interface 500 is shown in which a variety of screens, or views, may be presented. The administrative user interface 500 may be generated at a centralized compliance platform 102, in whole or in part, for communication to and display at a user device 108, as described above in conjunction with FIGS. 1-2, to achieve at least some of the advantages described previously.

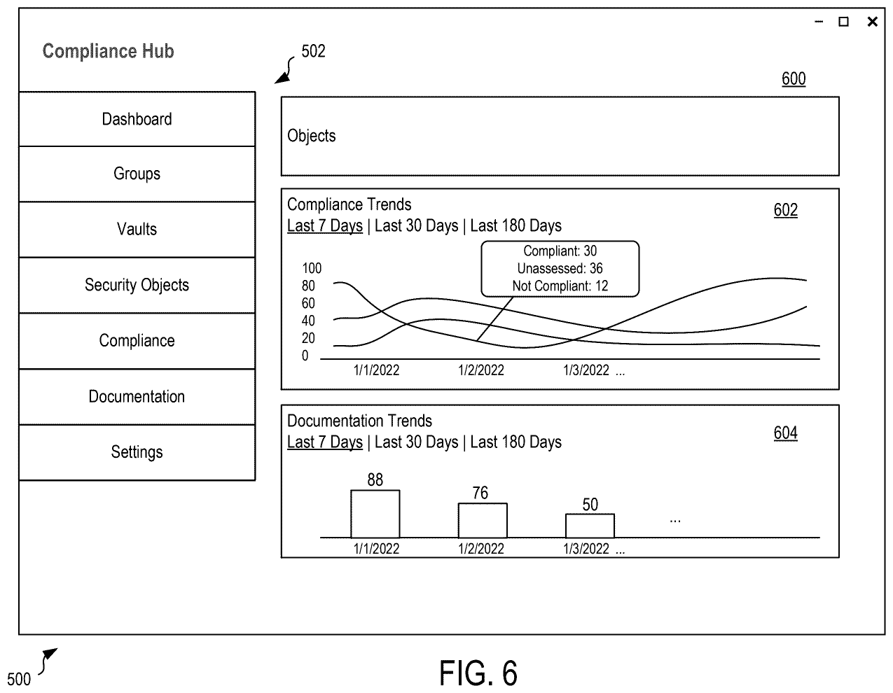

FIGS. 5-6 illustrate views 550, 600, respectively, of the administrative user interface 500. As seen in FIG. 5, the user interface 500 includes a navigation bar 502 of selectable options, including a dashboard option, a groups option, a vaults option, a security objects option, a compliance option, a documentation option, and a settings option. Additionally, within a display area of the user interface 500, view 550 displays a map in which individual security object storage locations are depicted with location identifiers (illustrated as pins). Upon selection of one of the security object storage locations using a cursor or other input mechanism, details regarding that storage location may be displayed, including the location details, type of storage location, number of security objects maintained at the storage location, a risk score, and the like. Additionally, an overall snapshot of the enterprise may be provided, including a number or details as to the number of state security object storage locations (e.g., vaults), the extent of compliance with enterprise policies, risk scores associated with security object storage locations, and a definition of the extent to which objects are documented.

As seen in FIG. 6, a further view 600, which may be presented within the same or a different menu area as view 550, is illustrated. View 600 includes one or more displayable regions, including a compliance chart 602 and a documentation chart 604. The compliance chart 602 and documentation chart 604 may be user manipulable to determine trends over various periods of time, as well as snapshots of current and past compliance or documentation status.

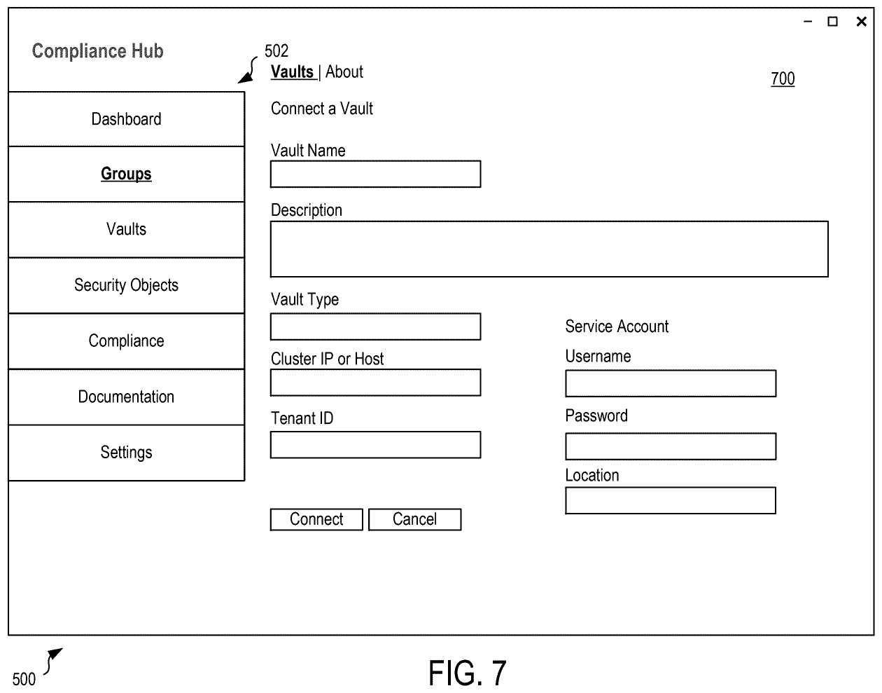

FIG. 7 illustrates the user interface 500, and presents a vault connection view 700 within that user interface. In particular, in response to selection of the groups option within the navigation bar 502, view 700 includes a plurality of input fields in which connection details for a particular security object storage location are obtained, e.g., from an administrative user. In the example shown, security details obtained via the vault connection view 700 may include a vault name, description, vault type, IP address or host name, and tenant ID. Additionally, authentication information may be provided, including a username and password. Optionally, location information may be obtained as well. The information entered on view 700 may be used to register a vault (or other security object storage location), and a risk score may be calculated for the registered vault, as described herein.

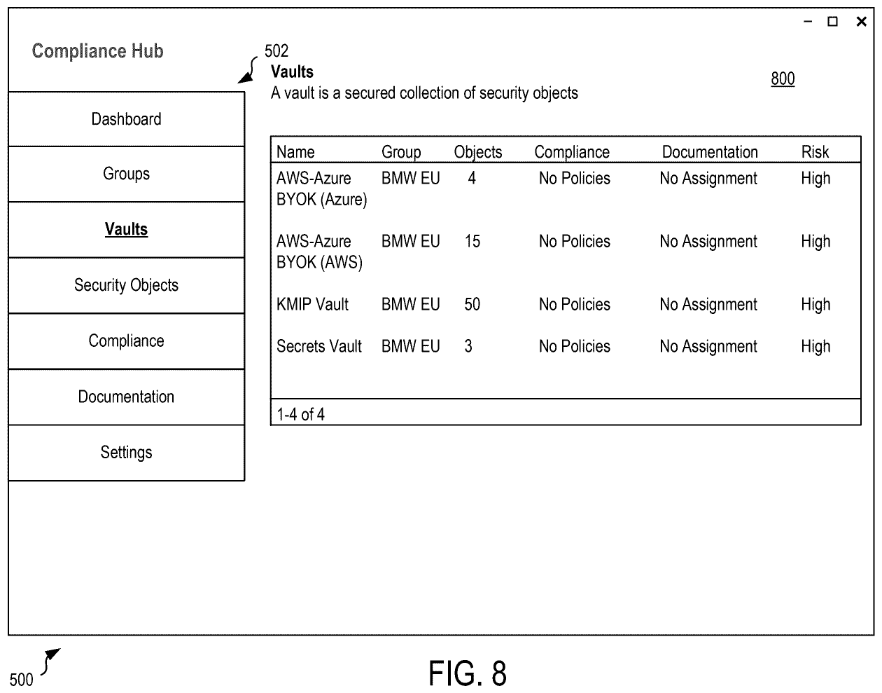

FIG. 8 illustrates the user interface 500, and presents a vault summary view 800 within that user interface. In particular, in response to selection of the vaults option, a listing of accessible security object storage locations (in this example, key or secret vaults) is provided. The listing may include a name, group, number of security objects maintained therein, compliance status, documentation status, and calculated risk score associated with each storage location. Other types of information may be presented as well.

In the illustrated embodiment, the risk score is presented as classifications (low, medium, high). The classifications may be based on numerical risk scores, where ranges of risk scores are assigned particular classifications (e.g., a risk score between 1 and 10 is classified as low). In alternative embodiments, the presented risk score may be numerical.

In the particular example user interface as presented, each of the security objects is associated with a documentation status, a compliance status, and a risk score. In this example, because there is no associated documentation, the risk score is by default assigned to a “HIGH” risk status. Once documentation is associated and associated with a particular security object, that documentation regarding properties of the security object may be assessed relative to compliance rules by the scorer, and the compliance status and risk score information may be updated.

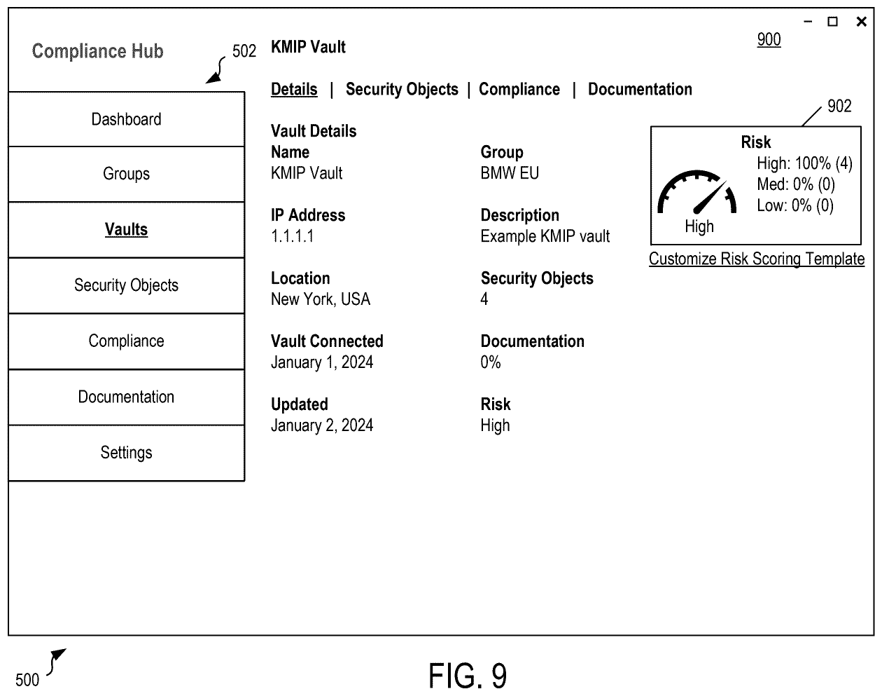

FIG. 9 illustrates a vault details view 900 within the user interface 500. In the illustrated embodiment, the vault details view 900 includes information associated with a selected vault, including a name, group, IP address, description, location, number of security objects, connection date, documentation rate, update date, and risk. In alternative embodiments additional or alternative information may be included in the view 900, such as a vault ID and unique ID (UU ID), owner contact information and owner name, a security object type stored in the vault (e.g., symmetric, asymmetric, etc.), and vault type (e.g., a Key Management Interoperability Protocol (KMIP) vault, a secrets vault, or a Transparent Data Encryption (TDE) key vault).

The view 900 further includes a risk display window 902 presenting the risk score associated with the selected vault. In the illustrated embodiment, the risk display window 902 includes a classification of the risk scores of the security objects included in the vault as well as the overall risk score for the vault. In this example, the risk scores are presented as classifications (e.g., high) for the vault and for the individual security objects maintained within the vault. In alternative examples, the risk scores may be presented in a numerical format for the vault, the security objects, or both. Further included in the vault details view 900 is an option to customize the risk scoring template used to calculate the risk score for the selected vault.

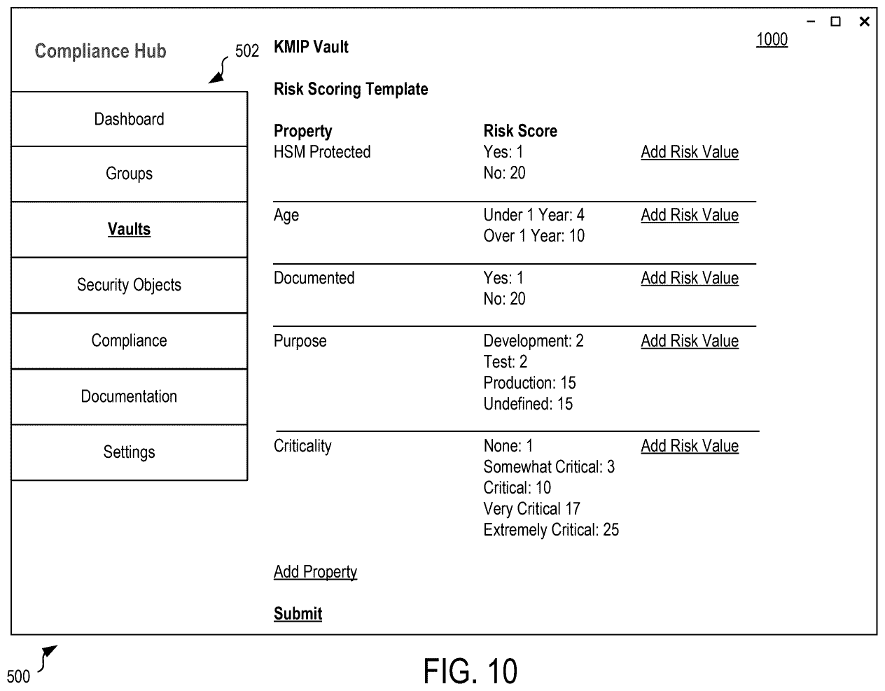

FIG. 10 illustrates a template editing view 1000 within the user interface 500. As described above, the risk scoring templates define how security objects and security object scoring locations are scored. The risk scoring templates may further be used to identify what metadata is retrieved for a security object; if a property is included in the risk scoring template, metadata associated with the property should be retrieved. In the illustrated embodiment, the view 1000 presents a user with options to edit the mappings between properties of a security object and a risk score. The view 1000 presents an example mapping of properties to scores; however, in alternative examples different mappings may be used and additional or alternative properties may be considered in the risk scoring template. Further options discussed above may additionally or alternatively be presented, such as a calculation method for the overall risk score for the security object storage location (e.g., average or maximum of the risk scores for the security objects maintained within the security object storage location).

The risk scoring template may be connected to a documentation template, which defines what documentation information a user can enter regarding a security object. By connecting with a documentation template, properties defined by the documentation template (e.g., purpose and criticality) may be mapped to risk scores.

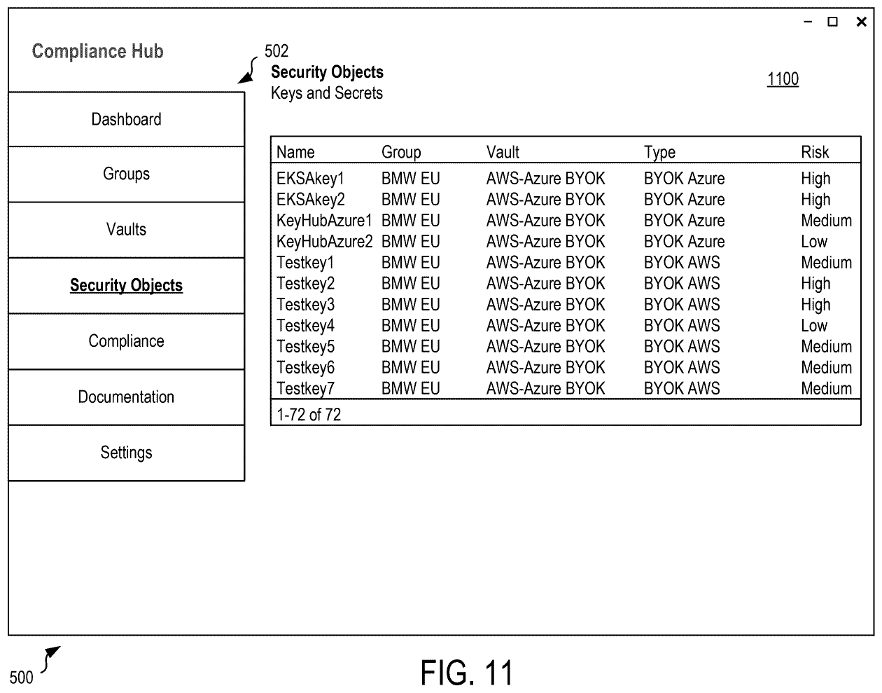

FIG. 11 illustrates a further view generated within the user interface 500, in particular a security objects view 1100 displayed in response to selection of the security objects option within the navigation bar 502. In this example, each of the available security objects from each storage location may be displayed by name, group, storage location, type, and risk score. A date of creation may be displayed as well. As in previous examples, the risk score is presented as a classification (e.g., low, medium, and high). In alternative embodiments, a numerical risk score may be presented.

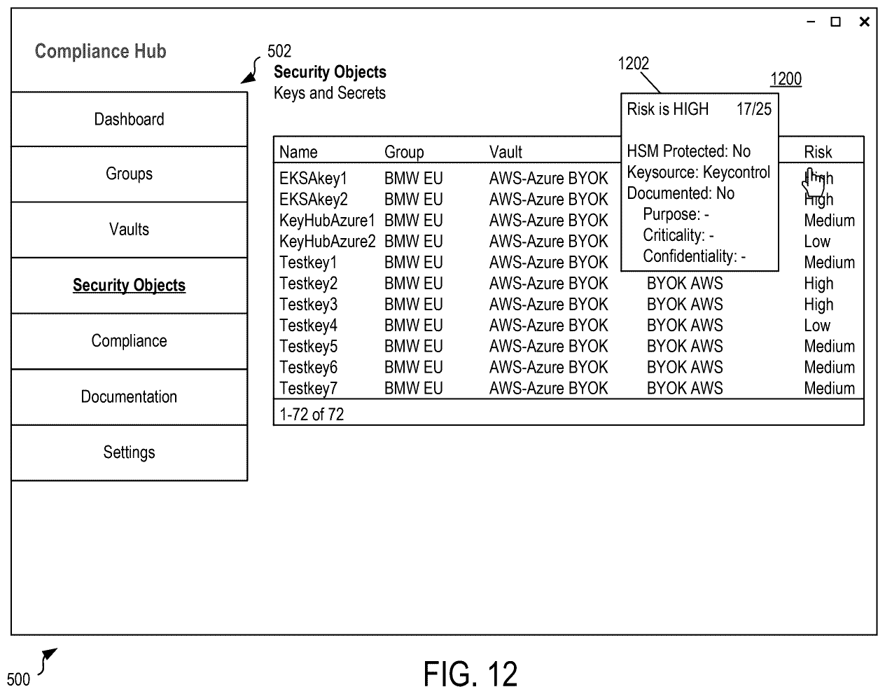

FIG. 12 illustrates an additional security objects view 1200 displayed in the user interface 500. When a user hovers a cursor over a risk score for a security object, a detailed risk score window 1202 is presented. The risk score window 1202 may include additional information regarding how the risk score was calculated. In the illustrated embodiment, the risk score window 1202 includes a numerical representation of the risk score as well as the properties that were considered in the calculation of the risk score. As described above, the properties considered in calculating a risk score for a security object may be defined by a risk score template. In further embodiments, additional or alternative information may be included in the risk score window 1202. Similarly, while not shown for ease of illustration, a similar risk score window may be presented to show information about the calculation of a risk score for a security object storage location (e.g., in the view 800 shown in FIG. 8 above).

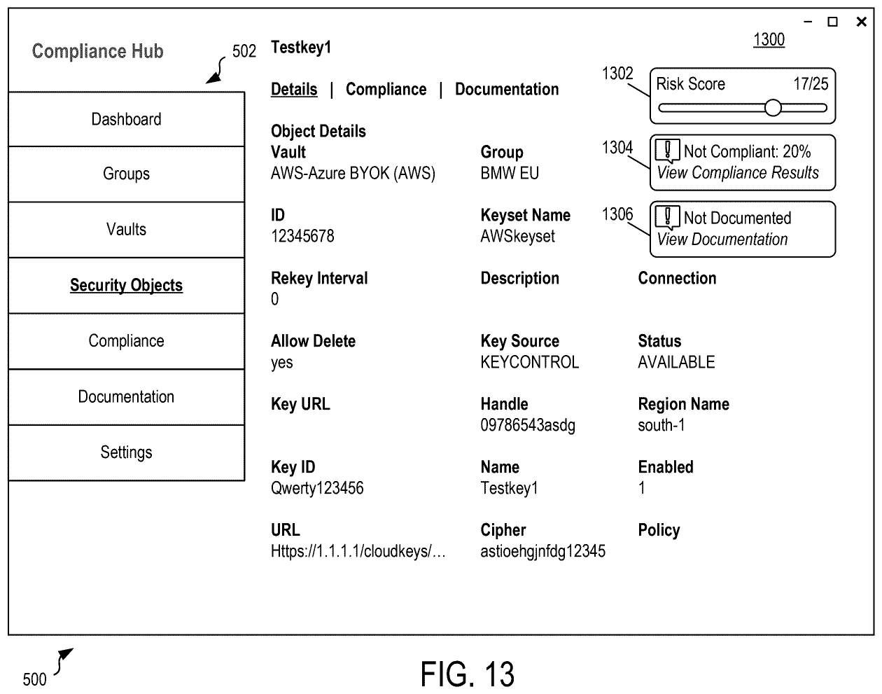

In response to selection of a particular one of the security objects in one of views 1100 or 1200, a further security objects view 1300 may be displayed within the user interface 500, as seen in FIG. 13. In particular, details regarding the selected security object may be depicted. In the example shown, the security object that is selected corresponds to a key maintained within a key vault, and the details include a vault name, vault group, identifier, keyset name, expiration action, rekeying interval, deletion permission, a key source, an availability status, as well as a uniform resource locator (URL), cipher, and policy information associated with the key. Other information may be presented as well.

In the example shown, the security objects view 1300 includes a risk score window 1302 as well as a compliance alert 1304 and a documentation alert 1406. The risk score presented in the risk score window 1302 may be calculated based on properties of the security object and a risk scoring template, as described above. The compliance alert 1304 may be generated automatically in response to comparison of key details to one or more compliance policies, such as a rekeying or key expiration policy, or a key strength policy. The compliance alert 1304 may optionally include a selectable option to display additional details regarding a reason for compliance or non-compliance, and may include a rating or percentage compliant score indicating the extent to which the selected security object (e.g., key), is non-compliant. Similarly, the documentation alert 1306 may be automatically generated in response to missing documentation regarding the security object (e.g., an entirely or partially missing policy against which compliance may be assessed, or documentation about the security object itself). Similar compliance alerts and documentation alerts may be presented in vault detail views, such as view 900 shown in FIG. 9 described above.

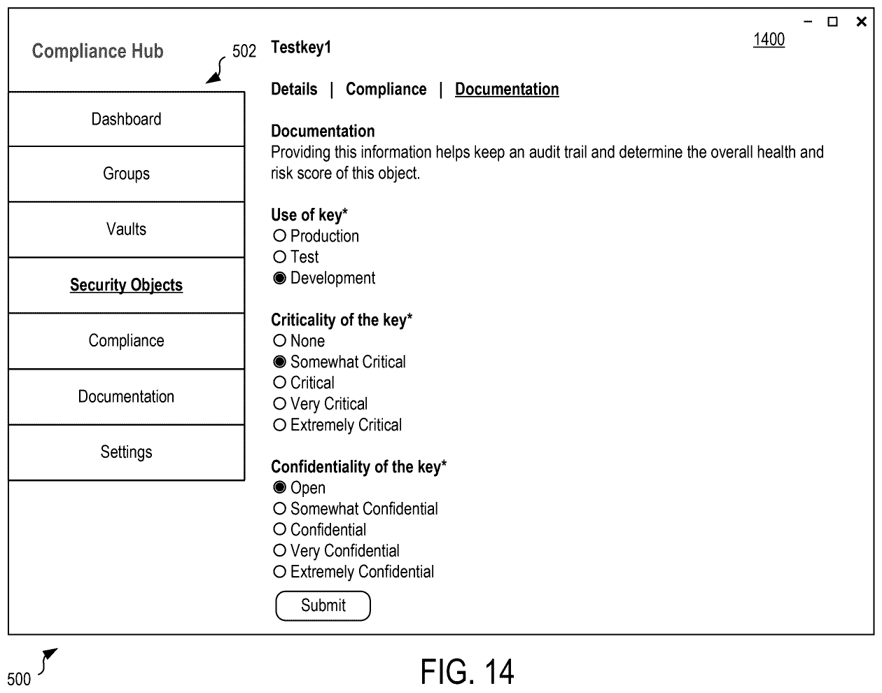

FIG. 14 shows a documentation information view 1400 within the user interface 500. In the illustrated embodiment, the documentation information view 1400 includes options for a user to enter documentation information associated with a security object. As described above, the type of documentation information to be collected from the user in the documentation information view 1400 may be specified by a documentation template. Further, the documentation information collected in the documentation information view 1400 may be used in calculating a risk score for a security object.

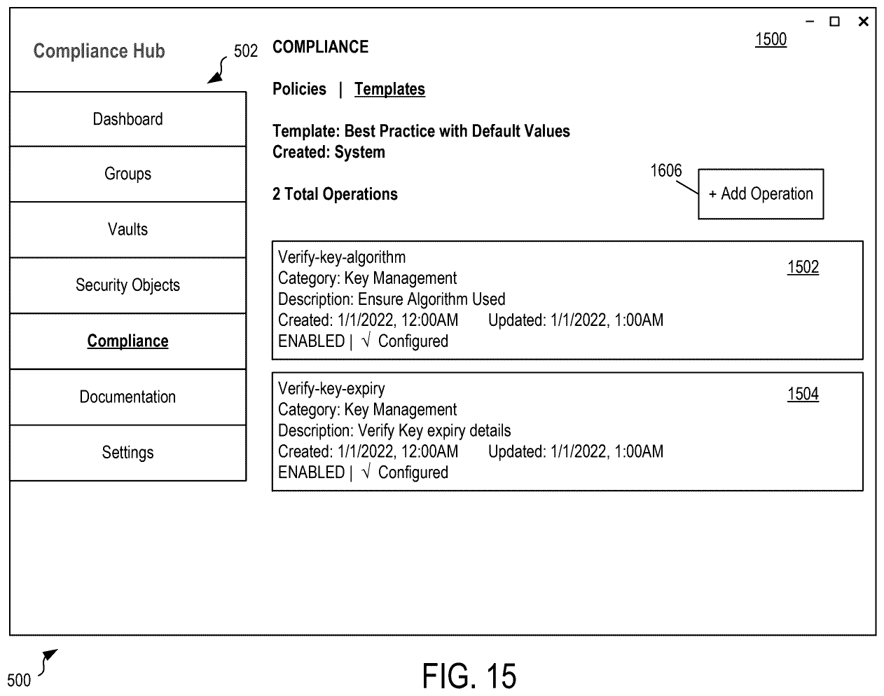

FIG. 15 shows a compliance view 1500 displayed within the user interface 500, in which a plurality of compliance operations may be defined. Compliance operations may include definitions of specific policies, or portions of policies, that may be centrally assessed and enforced by the centralized compliance platform 102. In the example shown, two such compliance operations are defined: a key verification algorithm 1502, in which a key algorithm test is performed to determine whether a key or key vault uses an appropriate key generation algorithm, and a key expiration verification algorithm 1504, in which a key expiry test is performed to determine whether a key managed at a particular key vault is set to expire within an acceptable time period (e.g., to ensure that stale keys are not used). The compliance view 1500 also includes an operation addition option 1506, which allows an administrative user to define one or more other compliance operations. The compliance operations may be used, at least in part, to determine a level of compliance by the various security objects and security object storage locations as reflected by compliance alert 1304 of FIG. 13, and also may be automatically sent to those storage locations to which the centralized compliance platform is connected. This ensures that those distributed storage locations maintain a common security policy, despite maintaining decentralized storage.

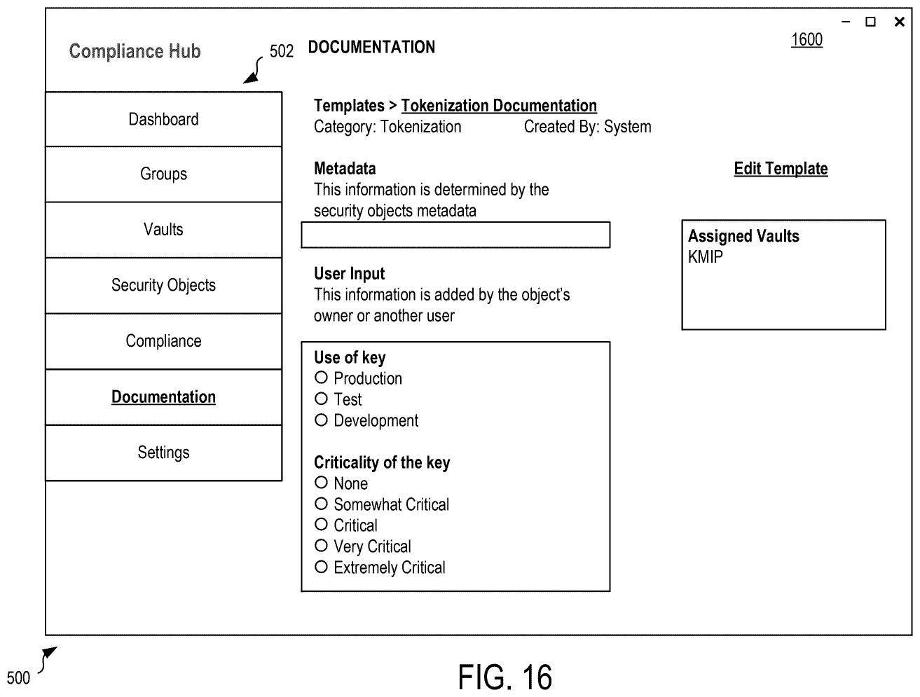

FIG. 16 shows a documentation template view 1600 displayed within the user interface 500. The documentation template view 1600 presents the settings of a documentation template. As described above, a documentation template may define the documentation information to be collected from a user regarding a security object. In the illustrated embodiment, the documentation template view 1600 includes a listing of the documentation information collected via user input as well as an indication of the security object storage locations that utilize the documentation template. The documentation template view 1600 further includes an option to edit the documentation template.

Referring to FIGS. 1-16 generally, it is noted that the centralized compliance platform described herein, including the various user interfaces and communicative connections to distributed storage locations, allows for centralized management of security objects of an enterprise, including a consolidated view of all such security objects and the associated risks with the security objects and security object storage locations. Additionally, management of security objects may be performed centrally despite maintaining security objects in decentralized, distributed storage locations. That is, for example, each key, secret, or certificate may be maintained in its distributed storage location, information about those locations and security objects may be retrieved and viewed, and policy compliance may be centrally assessed, with policy updates pushed to those distributed locations. This significantly simplifies the process of managing policy compliance for security objects without requiring centralized storage of security objects. Furthermore, because centralized storage is not required, the centralized management process is highly scalable.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

1. A method of managing security object storage locations, the method comprising:
registering, at a compliance management platform, a security object storage location, wherein the security object storage location maintains one or more security objects;
for each security object maintained in the security object storage location:
receiving metadata associated with the security object; and
assigning a risk score to the security object based on the received metadata;
calculating an overall risk score for the security object storage location based on the risk scores of the one or more security objects; and
generating an administrative user interface at the compliance management platform, the administrative user interface including a display of the overall risk score for the security object storage location.

2. The method of claim 1, wherein the metadata associated with the security object is received without receiving the security object.

3. The method of claim 1, wherein the metadata includes documentation information describing attributes of the security object from a user input.

4. The method of claim 3, wherein a type of documentation information included in the user input is defined by a documentation template.

5. The method of claim 4, wherein the documentation template is customizable.

6. The method of claim 1, wherein a type of metadata received is based on a risk score template.

7. The method of claim 6, wherein the risk score template is customizable.

8. The method of claim 1, wherein calculating the overall risk score for the security object storage location based on the risk scores of the one or more security objects includes:
calculating a weighted average of the risk scores of the one or more security objects.

9. The method of claim 1, wherein registering the security object storage location includes:
receiving, at the compliance management platform, connection parameters for the security object storage location, the connection parameters including a vault location and account details useable for access to the one or more security objects maintained within the security object storage location; and
based on the connection parameters, communicatively connecting the compliance management platform to the security object storage location.

10. The method of claim 1, wherein assigning the risk score to the security object based on the received metadata includes:
determining one or more properties of the security object based on metadata;
mapping a score to each of the one or more properties; and
calculating the risk score as an average of the scores mapped to the one or more properties.

11. The method of claim 10, wherein the one or more proper properties and the score mapped to each of the one or more properties are defined by a risk score template.

12. A security object compliance management platform comprising:
a computing system including a processor and memory, the memory storing instructions executable by the processor to:
register, at the security object compliance management platform, a security object storage location, wherein the security object storage location maintains one or more security objects;
for each security object maintained in the security object storage location:
receive metadata associated with the security object; and
assign a risk score to the security object based on the received metadata;
calculate an overall risk score for the security object storage location based on the risk scores of the one or more security objects; and
generate an administrative user interface at the security object compliance management platform, the administrative user interface including a display of the overall risk score for the security object storage location.

13. The security object compliance management platform of claim 12, wherein the metadata includes properties of the security object associated with compliance with a compliance policy.

14. The security object compliance management platform of claim 12, wherein the display of the overall risk score for the security object storage location includes a display of the risk scores of the one or more security objects maintained in the security object storage location.

15. The security object compliance management platform of claim 12, wherein the display of the overall risk score includes a numerical representation of the overall risk score.

16. The security object compliance management platform of claim 12, wherein the display of the overall risk score includes a classification of the overall risk score.

17. The security object compliance management platform of claim 12, wherein to assign the risk score to the security object based on the received metadata includes to:
map one or more scores to one or more properties of the security object identified in the metadata; and
calculate an average of the scores mapped to the one or more properties of the security object.

18. The security object compliance management platform of claim 17, wherein when a property is not defined in the metadata, a maximum value is mapped to the property.

19. The security object compliance management platform of claim 12, wherein the computing system is further configured to receive a user input of documentation information associated with a security object of the one or more security objects,
wherein documentation information is included in the metadata received for the security object.

20. A non-transitory computer-readable medium comprising computer-executable instructions installed thereon, the computer-executable instructions being executable by a computing system to cause the computing system to perform a method of managing compliance with security policies of an enterprise for one or more security objects maintained across a distributed set of security object storage locations, the method comprising:
registering, at a compliance management platform, a security object storage location, wherein the security object storage location maintains one or more security objects;
for each security object maintained in the security object storage location:
receiving metadata associated with the security object; and
assigning a risk score to the security object based on the received metadata;
calculating an overall risk score for the security object storage location based on the risk scores of the one or more security objects; and
generating an administrative user interface at the compliance management platform, the administrative user interface including a display of the overall risk score for the security object storage location.
